(19) United States
(12) Patent Application Publication
(10) Pub. No.: US 2006/0106481 A1
(43) Pub. Date: May 18, 2006

(54) Device and method for checking programs of numerical control machine

(75) Inventor: Chun-Yi Chang, Tu-Cheng, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry Co., LTD., Tu-Cheng City (TW)

(21) Appl. No.: 11/273,816

(22) Filed: Nov. 14, 2005

(30) Foreign Application Priority Data
Nov. 12, 2004 (CN) 200410052263.3

(51) Int. Cl. G06F 19/00

(52) U.S. Cl. 700/178; 700/177

(57) ABSTRACT

A device for a checking program of numerical control machine comprises a tool rest (100) and a lamp-house (103). The tool rest is mounted on a numerical control machine (10). The lamp-house is assembled on the tool rest and emits light. A method for checking a program of numerical control machine comprises the steps of: (1) inputting a program in the numerical control machine; (2) providing an above-said device for checking programs. The lamp-house faces a workpiece (110) on the numerical control machine; (3) moving the tool rest with the lamp-house away from the workpiece; (4) turning on the numerical control machine and the lamp-house. The lamp-house moves according to the program in the numerical control machine. The light emitted by the lamp-house irradiates on the workpiece and forms a path. Then workers can judge the program is correct or not by the path of light emitted by the lamp-house.

### FIELD OF THE INVENTION

The present invention generally relates to devices and methods for checking correctness of computer programs before the programs are run, and more particularly to a device and method for checking programs of a numerical control (NC) machine.

### BACKGROUND

On the production line of a factory, a high degree of automatization using numerical control machines reduces the need for manual labor and improves production efficiency. In addition, numerical control machines can achieve the machining of complex curved surfaces that ordinary machines cannot achieve. Therefore, numerical control machines are becoming more and more important and popular.

During a machining process using a numerical control machine, a path traveled by a machining tool is dependent upon programs inputted to the machine. The program must be correct and accurate; otherwise the tool is liable to collide with the workpiece or the machine. Collision may result in the tool, the workpiece or the machine being damaged, or in a machine operator being injured. Therefore, a device and related method are needed to check whether the program is correct. One kind of conventional method for checking programs is to manually inspect them. However, it is difficult to manually check complex programs, and such checking is subject to human error. Another kind of conventional method for checking programs is to raise the tool to ensure that the tool cannot contact the workpiece, and then turn on the machine. Then an operator can check the path traveled by the tool as the machine runs. However, an operator may not correctly judge the exact position of the tool tip. If the operator makes a mistake, the tool is liable to collide with the workpiece or the machine.

What is needed, therefore, is a simple and reliable device and method for checking programs in a numerical control machining.

### SUMMARY

A device for checking a program of a numerical control machine comprises a tool rest and a lamp-house. The tool rest is mounted on the numerical control machine. The lamp-house is assembled on the tool rest and can emit a beam of light.

A method for checking a program of a numerical control machine comprises the steps of: (1) inputting a program in the numerical control machine; (2) providing a device for checking the program of numerical control machine. The device comprises a tool rest and a lamp-house. The tool rest is mounted on the numerical control machine. The lamp-house is assembled on the tool rest. The lamp-house is adapted to face a workpiece mounted on the numerical control machine and emits slight; (3) moving the tool rest with the lamp-house away from the workpiece; and (4) turning on the numerical control machine and the lamp-house. The lamp-house moves according to the program in the numerical control machine. The light emitted by the lamp-house irradiates on the workpiece and forms a path. Then workers can judge the program is correct or not by the path of light emitted by the lamp-house.

In use of the device and the method, workers can precisely and easily determine whether the programs are correct. Therefore, the risk of collision between the tool and the workpiece or the machine can be reduced or even eliminated.

Other advantages and novel features of preferred embodiments of the present invention will become more apparent from the following detailed description when taken in conjunction with the accompanying drawings, in which:

### BRIEF DESCRIPTION OF THE DRAWINGS

FIG. 1 is an isometric view of a device for checking programs of a numerical control machine in accordance with a preferred embodiment of the present invention, the device being attached on the machine;

FIG. 2 is a schematic, cross-sectional view of the device of FIG. 1 operating above a workpiece, showing a situation whereby a tool of the machine will not collide with the workpiece during actual manufacture; and

FIG. 3 is similar to FIG. 2, but showing a situation whereby the tool will collide with the workpiece.

### DETAILED DESCRIPTION OF PREFERRED EMBODIMENTS

A device for checking machining programs of a numerical control machine is used to check whether programs inputted in the numerical control machine are correct. The method for checking a program of a numerical control machine checks the program by checking a path traveled by a tool that is to be used in actual machining of a workpiece by the machine.

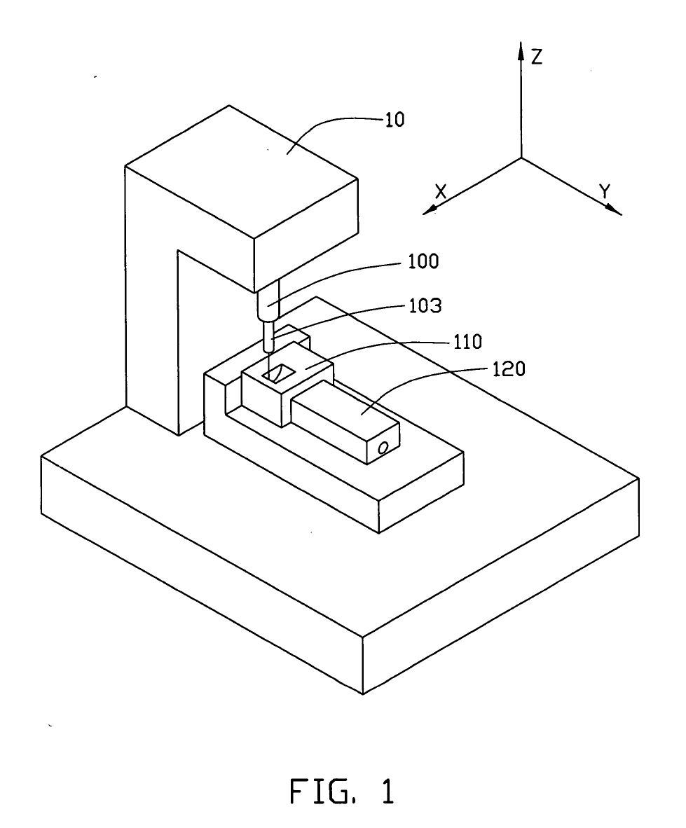

Referring to FIG. 1, the device for checking programs of a numerical control machine includes a tool rest 100 and a lamp-house 103 as a light source. The lamp-house 103 is mounted on the tool rest 100 and can emit a beam of laser light. A lamp switch (not shown) for controlling the lamp-house 103 is located on the lamp-house 103. The tool rest 100 is mounted on the machine.

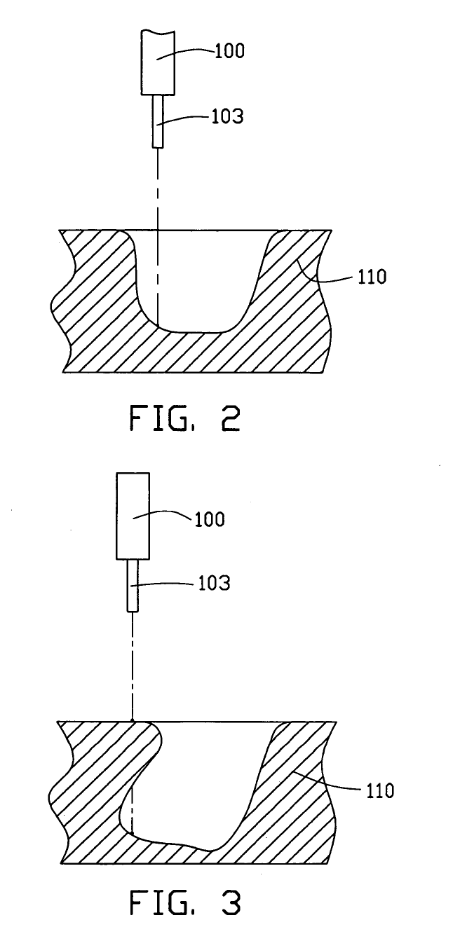

In order to simplify the description of the preferred embodiment of the present invention, the following description is made with reference to Cartesian axes, as shown in FIG. 1. The lamp-house 103 oriented parallel to the Z axis. Firstly, a program is inputted into a numerical control machine 10. Next, the workpiece 110 is fixed on the numerical control machine 10 by a fixture 120. The lamp-house 103 is attached at an underside of the tool rest 100, and is oriented parallel to the Z axis. Then, the tool rest 100 with the lamp-house 103 is raised away from the workpiece 110, so that the lamp-house 103 cannot contact the workpiece 110. The lamp-house 103 is turned on and emits laser light. The laser light vertically irradiates the workpiece 110. A diameter of a spot formed by the laser light on the workpiece 110 is the same as a diameter of a tool (not shown) to be used in actual manufacture. Finally, the numerical control machine 10 is turned on, and runs according to the program in the numerical control machine 10. The light emitted by the lamp-house 103 forms a path on the workpiece 110. The path is same as the path of the tool to be used in actual manufacture. Then workers can judge whether the path of the program is correct by determining whether the path of light on the workpiece 110 is the desired path. Referring to FIG. 2, if the light emitted by the lamp-house 103 directly irradiates a machined surface, then the tool will not collide with the workpiece 110 in actual manufacture, and the program is correct. Referring to FIG. 3, if the light emitted by the lamp-house 103 cannot directly irradiate a machined surface, the tool will collide with the workpiece 110 in actual manufacture, and the program is incorrect.

In other exemplary embodiments, the lamp-house 103 can be configured to be parallel to the X axis or the Y axis. In such cases, the tool rest 100 is first moved away from the workpiece 110 in a direction parallel to the X axis or the Y axis.

It is believed that the embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

I claim:

1. A device for checking programs of a numerical control machine, comprising:
a tool rest mounted on the numerical control machine; and
a lamp-house assembled on the tool rest, wherein the lamp-house can emit a beam of light.

2. The device for checking programs of a numerical control machine as claimed in claim 1, wherein the lamp-house is a laser lamp-house that can emit laser light.

3. The device for checking programs of a numerical control machine as claimed in claim 1, wherein the lamp-house has a switch.

4. The device for checking programs of a numerical control machine as claimed in claim 1, wherein a diameter of a spot of light irradiated on a workpiece by the lamp-house is substantially the same as a diameter of a tool to be used with the workpiece in actual manufacture.

5. A method for checking a program of a numerical control machine, comprising the steps of:
inputting a program in the numerical control machine;
providing a device for checking the program of numerical control machine, the device comprising a tool rest mounted on the numerical control machine and a lamp-house assembled on the tool rest, the lamp-house being adapted to face a workpiece mounted on the numerical control machine and emit light;
moving the tool rest with the lamp-house away from the workpiece; and
turning on the numerical control machine and the lamp-house, moving the lamp-house according to the program in the numerical control machine, irradiating the workpiece with light emitted by the lamp-house.

6. The method for checking a program of a numerical control machine as claimed in claim 5, wherein the lamp-house is a laser lamp-house that can emit laser light.

7. The method for checking program of numerical control machine as claimed in claim 5, wherein the lamp-house has a switch.

8. The method for checking program of numerical control machine as claimed in claim 5, wherein a diameter of a spot of light irradiated on a workpiece by the lamp-house is substantially the same as a diameter of a tool to be used with the workpiece in actual manufacture.

9. A method for verifying a machining program of a machine, comprising the steps of:
retrieving a machining program of a machine comprising instructive ways for machining a workpiece;
preparing a light source emitting light capable of simulating at least one machining tool of said machine applied by said machining program;
installing said light source on said machine beside said workpiece fixed on said machine; and
evaluating machining results of said machining program by examining interaction of said light with said workpiece fixed on said machine according to applying of said machining program on light emitting of said light source.

10. The method as claimed in claim 9, wherein said machining results are evaluated by means of examining irradiation of said light on said workpiece.
